(19) United States
(12) Patent Application Publication
(10) Pub. No.: US 2003/0188616 A1
(43) Pub. Date: Oct. 9, 2003

(54) Compliant cutting die apparatus for cutting fuel cell material layers

(76) Inventor: Lance E. Behymer, Woodbury, MN (US)

Correspondence Address: 3M INNOVATIVE PROPERTIES COMPANY, PO BOX 33427, ST. PAUL, MN, 55133-3427, US

(21) Appl. No.: 10/115,513

(22) Filed: Apr. 3, 2002

(51) Int. Cl. B26D 5/08; B26F 1/14

(52) U.S. Cl. 83/613; 83/684

(57) ABSTRACT

A cutting apparatus for use with a platen die station is employed for cutting relatively thin planar material layers, such as thin material layers used in the construction of fuel cells. The cutting apparatus includes a die having a substantially planar first surface and a substantially planar second surface. A cutting surface and at least one bearer surface respectively protrude from the first surface of the die. A height of the bearer surface is substantially equal to a height of the cutting surface, such that the bearer surface prevents damage to the cutting surface when the cutting surface and bearer surface are moved to contact an anvil surface of the platen die station. One or more layers of a compliant material, such as polyethylene or polypropylene, may be situated in contact with the second surface of the die to add compliance to the cutting apparatus.

### FIELD OF THE INVENTION

The present invention relates generally to cutting dies and, more particularly, to a cutting die and cutting station for use in cutting relatively thin material layers, such as material layers of a fuel cell.

### BACKGROUND OF THE INVENTION

Various types of cutting dies have been developed to cut and perforate a wide variety of materials. One type of cutting die apparatus is referred to as a rotary cutting die. Rotary dies are typically mounted onto magnetic steel rolls. These steel rolls provide an extremely rigid support for the die. A rotary die cuts against a steel anvil roll.

Another type of cutting die apparatus is referred to as a platen style die. A platen die station incorporates a cutting die and an anvil which are brought into contact axially under force. Both platen and rotary die stations are useful in many applications. However, limitations inherent in conventional rotary and platen die apparatuses render these cutting devices less than optimal when cutting relatively thin layers of material, such as materials having a thickness of about 0.001 inches.

There is a need for an improved cutting apparatus which is well suited for cutting relatively thin layers of material, such as materials used in the construction of fuel cells. There is a further need for an improved cutting apparatus that exploits beneficial attributes of both rotary and platen style die apparatuses. The present invention fulfills these and other needs.

### SUMMARY OF THE INVENTION

The present invention is directed to a cutting apparatus for use with a platen die station for cutting relatively thin planar material layers. The cutting apparatus of the present invention is particularly well suited for cutting thin material layers used in the construction of fuel cells. According to one embodiment, the cutting apparatus includes a die having a substantially planar first surface and a substantially planar second surface. A cutting surface protrudes from the first surface of the die.

The cutting apparatus further includes at least one bearer surface that protrudes from the first surface of the die. A height of the bearer surface is substantially equal to a height of the cutting surface, such that the bearer surface prevents damage to the cutting surface when the cutting surface and bearer surface are moved to contact an anvil surface of the platen die station. One or more layers of a compliant material, such as polyethylene or polypropylene, may be situated in contact with the second surface of the die to add compliance to the cutting apparatus.

In accordance with another embodiment, a platen die assembly incorporates a cutting apparatus for cutting relatively thin planar material layers. The plate die assembly includes a first plate and a second plate. The second plate includes an anvil surface. The first plate and second plate are arranged to permit relative movement therebetween.

A die of the platen die assembly includes a substantially planar first surface and a substantially planar second surface. The second surface of the die is affixed to the first plate. A cutting surface protrudes from the first surface of the die. At least one bearer surface protrudes from the first surface of the die. A height of the bearer surface is substantially equal to a height of the cutting surface.

A controllable actuator effects contact between the first and second plates. The bearer surface prevents damage to the cutting surface when the cutting surface and bearer surface are moved to contact the anvil surface of the second plate under pressure. One or more layers of a compliant material may be situated between the second surface of the die and the first plate to add compliance to the cutting apparatus.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is an illustration of a fuel cell and its constituent layers;

FIG. 2 is an illustration of a cutting die employing cutting and bearer stop features in accordance with an embodiment of the present invention;

FIG. 3 is another view of the cutting die shown in FIG. 2; and

FIG. 4 is an illustration of a cutting die station employing a cutting die having cutting and bearer stop features in accordance with an embodiment of the present invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

A cutting die apparatus of the present invention can be employed to cut relatively thin material layers. For example, a cutting die apparatus of the present invention is well suited for cutting layers of materials used in the construction of fuel cell. The material layers used to construct a fuel cell can have a thickness of about 0.001 inches. Such materials can have varying porosity and can vary in terms of brittleness. One skilled in the art will readily appreciate that accurately and safely cutting thin materials, such as those used in fuel cell construction, is a significant challenge.

A cutting die apparatus of the present invention effectively exploits several beneficial features of rotary cutting dies and adapts such features for use on platen presses. In addition, a cutting die apparatus of the present invention incorporates one or more stops or bearers built into the cutting die. The built-in bearers operate to control the stroke of a cutting press that employs a cutting die apparatus of the present invention. Integration of one or more stops or bearers built into the cutting die advantageously eliminates the need for stops arranged external of the cutting die. Such external stops are known to be expensive and require careful adjustment by a skilled machinist after each die change.

According to an embodiment of the present invention, the height of the bearer or bearers of the cutting die apparatus matches the height of the cutting surface of the cutting die apparatus. Because the heights of the bearer and cutting surfaces are matched on the cutting die, the risk of crushing the cutting surface is significantly reduced, if not eliminated.

Conventional platen die apparatuses often employ a sacrificial soft material, such as nylon, as a receiving surface (i.e., anvil surface) that contacts the cutting surface of the die at the end of the press stroke. Although this approach reduces the likelihood of undesirable crushing of the cutting surface, the relative softness of the nylon receiving surface provides insufficient support and stability when attempting to cut relatively thin material layers on the order of 0.001 inches in thickness.

Because the heights of the bearer and cutting surfaces are matched on the cutting die, the receiving or anvil surface of a platen press that employs a cutting die apparatus of the present invention can be made of hard material, such as a high strength metal suitable for use as an anvil. Integration of the bearer and cutting surfaces onto a cutting die apparatus of the present invention allows for the use of a hard anvil surface, which is a beneficial feature of rotary cutting dies heretofore unavailable using conventional platen die cutting techniques as applied to the cutting of very thin layers of material.

In accordance with another embodiment of the present invention, the cutting die apparatus can include a thin compliant material situated between the non-cutting surface of the cutting die apparatus and a platen press surface. It is well understood by those skilled in the art that cutting thin material layers, such as fuel cell layers on the order of 0.001 inches in thickness, using certain cutting dies can be problematic where the cutting surface height varies along the length of the cutting surface. For example, the height of the cutting surface of a particular cutting die can vary by about 0.0005 inches. This variation in cutting surface height is largely due to inaccuracies in the cutting die fabrication process. According to this embodiment, a small amount of compliance is integrated into the cutting die apparatus. By adding a slightly compliant support behind the cutting die, very thin materials can be cleanly cut, and any slight variation in cutting die height can be accommodated without adversely affecting the cutting process. Further, employment of a compliant material behind the cutting die provides for cutting of very thin materials against a hard anvil surface.

A cutting die apparatus of the present invention can be employed to facilitate automated cutting of material layers defining a fuel cell or a portion of a fuel cell. A fuel cell is an electrochemical device that combines hydrogen fuel and oxygen from the air to produce electricity, heat, and water. Fuel cells do not utilize combustion, and as such, fuel cells produce little if any hazardous effluents. Fuel cells convert hydrogen fuel and oxygen directly into electricity, and can be operated at much higher efficiencies than internal combustion electric generators, for example.

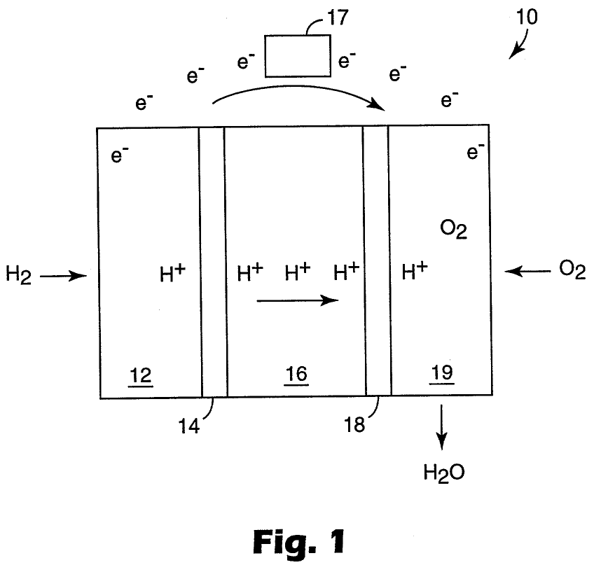

A typical fuel cell is depicted in FIG. 1. The fuel cell 10 shown in FIG. 1 includes a first fluid transport layer 12 adjacent an anode 14. Adjacent the anode 14 is an electrolyte membrane 16. A cathode 18 is situated adjacent the electrolyte membrane 16, and a second fluid transport layer 19 is situated adjacent the cathode 18. In operation, hydrogen fuel is introduced into the anode portion of the fuel cell 10, passing through the first fluid transport layer 12 and over the anode 14. At the anode 14, the hydrogen fuel is separated into hydrogen ions (H⁺) and electrons (e⁻).

The electrolyte membrane 16 permits only the hydrogen ions or protons to pass through the electrolyte membrane 16 to the cathode portion of the fuel cell 10. The electrons cannot pass through the electrolyte membrane 16 and, instead, flow through an external electrical circuit in the form of electric current. This current can power an electric load 17, such as an electric motor, or be directed to an energy storage device, such as a rechargeable battery.

Oxygen flows into the cathode side of the fuel cell 10 via the second fluid transport layer 19. As the oxygen passes over the cathode 18, oxygen, protons, and electrons combine to produce water and heat.

Individual fuel cells, such as that shown in FIG. 1, can be combined with a number of other fuel cells to form a fuel cell stack. The number of fuel cells within the stack determines the total voltage of the stack, and the surface area of each of the cells determines the total current. The total electrical power generated by a given fuel cell stack can be determined by multiplying the total stack voltage by total current.

A cutting die apparatus of the present invention can be employed to facilitate automated cutting of material layers in the construction of fuel cells of varying technologies. For example, a cutting die apparatus of the present invention can be employed to cut material layers used to construct proton exchange membrane (PEM) fuel cells. PEM fuel cells operate at relatively low temperatures (about 175 degrees F.), have high power density, can vary their output quickly to meet shifts in power demand, and are well suited for applications where quick startup is required, such as in automobiles for example.

The proton exchange membrane used in a PEM fuel cell is a thin plastic sheet that allows hydrogen ions to pass through it. The membrane is coated on both sides with highly dispersed metal or metal alloy particles (e.g., platinum or platinum/ruthenium) that are active catalysts. The electrolyte used is typically a solid organic polymer poly-perfluorosulfonic acid. Use of a solid electrolyte is advantageous because it reduces corrosion and management problems.

Hydrogen is fed to the anode side of the fuel cell where the catalyst encourages the hydrogen ions to release electrons and become hydrogen ions (protons). The electrons travel in the form of an electric current that can be utilized before it returns to the cathode side of the fuel cell where oxygen has been introduced. At the same time, the protons diffuse through the membrane to the cathode, where the hydrogen ions are recombined and reacted with oxygen to produce water.

According to one PEM fuel cell construction, a PEM layer is sandwiched between a pair of fluid transport layers (FTLs), such as diffuse current collectors or gas diffusion layers for example. An anode is situated between a first FTL and the membrane, and a cathode is situated between the membrane and a second FTL. In one configuration, a PEM layer is fabricated to include an anode catalyst coating on one surface and a cathode catalyst coating on the other surface. According to another configuration, the first and second FTLs are fabricated to include an anode and cathode catalyst coating, respectively. In yet another configuration, an anode catalyst coating can be disposed partially on the first FTL and partially on one surface of the PEM, and a cathode catalyst coating can be disposed partially on the second FTL and partially on the other surface of the PEM. The five layer construct defined by the first FTL/anode/PEM/cathode/second FTL is referred to as a membrane electrode assembly (MEA).

The FTLs are typically fabricated from a carbon fiber paper or non-woven material. Depending on the product construction, the FTLs can have carbon particle coatings on one side. The FTLs, as discussed above, can be fabricated to include or exclude a catalyst coating. The FTLs, according to this product construction, are both porous and brittle. A cutting die apparatus consistent with the principles of the present invention is particularly well suited for accurately cutting thin, fuel cell layers, such as PEM layers and FTLs for example, during automated fuel cell assembly.

Direct methanol fuel cells (DMFC) are similar to PEM cells in that they both use a polymer membrane as the electrolyte. In a DMFC, however, the anode catalyst itself draws the hydrogen from liquid methanol fuel, eliminating the need for a fuel reformer. DMFCs typically operate at a temperature between 120-190 degrees F.

Molten carbonate fuel cells (MCFC) use a liquid solution of lithium, sodium and/or potassium carbonates, soaked in a matrix for an electrolyte. MCFCs operate at about 1,200 degrees F. The high operating temperature is needed to achieve sufficient conductivity of the electrolyte. Because of this high temperature, noble metal catalysts are not required for the cell's electrochemical oxidation and reduction processes. MCFCs are typically operated on hydrogen, carbon monoxide, natural gas, propane, landfill gas, marine diesel, and simulated coal gasification products.

A solid oxide fuel cell (SOFC) typically employs a hard ceramic material of solid zirconium oxide and a small amount of ytrria, instead of a liquid electrolyte, allowing operating temperatures to reach 1,800 degrees F.

In regenerative fuel cells, water is separated into hydrogen and oxygen by a solar-powered electrolyser. The hydrogen and oxygen are fed into the regenerative fuel cell which generates electricity, heat, and water. The water is then recirculated back to the solar-powered electrolyser and the process is repeated.

A protonic ceramic fuel cell (PCFC) employs a ceramic electrolyte material that exhibits high protonic conductivity at elevated temperatures. PCFCs operate at about 1,300 degrees F. PCFCs can operate at high temperatures and electrochemically oxidize fossil fuels directly to the anode. Gaseous molecules of the hydrocarbon fuel are absorbed on the surface of the anode in the presence of water vapor, and hydrogen ions are efficiently stripped off to be absorbed into the electrolyte, with carbon dioxide as the primary reaction product. These and other fuel cell technologies can be constructed from material layers cut by a cutting die apparatus in accordance with the present invention.

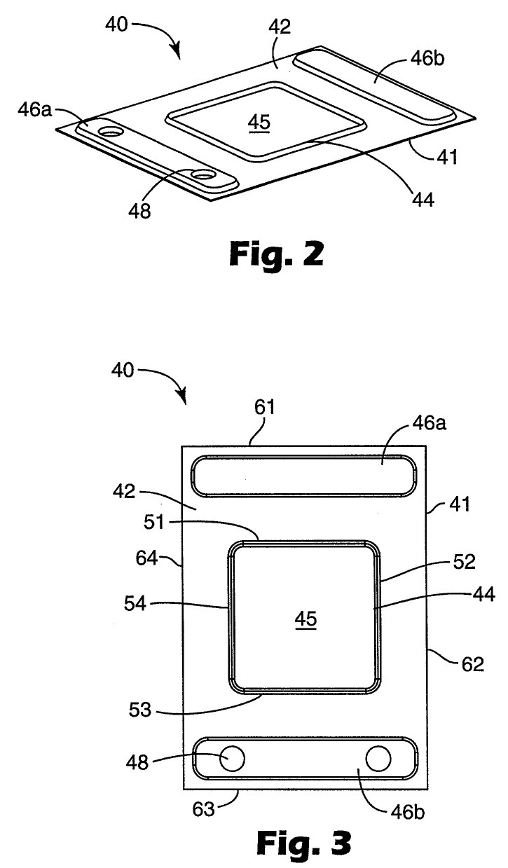

Turning now to FIGS. 2 and 3, there is illustrated an embodiment of a cutting die apparatus 40 according to an embodiment of the present invention. The cutting die apparatus 40 shown in FIGS. 2 and 3 includes a substantially planar die base 41. Provided on a top surface 42 of the die base 41 is a cutting surface 44, which is shown protruding from the top surface 42. Although FIGS. 2 and 3 show a single cutting surface 44, two or more cutting surfaces 44 can be provided on the top surface 42.

The cutting surface 44 is depicted as a continuous cutting edge. According to one configuration, the cutting surface has a substantially square shape, as in the case of the cutting surface 44 shown in FIGS. 2 and 3. The cutting surface 44 can also have a substantially rectangular shape. According to another configuration, the cutting surface can have a substantially oval or substantially circular shape. The shape of the cutting region 45 encompassed by the cutting surface 44 dictates the size and shape of the resultant material layer cut by the cutting surface 44. The shape of the cutting surface 44 can be varied according to the intended shape of the material layers subject to cutting using the cutting die apparatus 40.

According to other embodiments, the cutting surface 44 may be configured to include a discontinuous cutting edge. The cutting surface 44 may, for example, include one or more perforations, such as holes, breaks or other discontinuities. The cutting surface 44 may be defined by a number of loops of various shaped cutting edges. By way of further example, the cutting surface 44 may include a single large rectangular shaped edge with several small circular or elliptical cutting edges provided within the large rectangular shaped edge. It will be appreciated that many variations of cutting surface configurations are contemplated within the scope of the present invention.

The cutting surface 44 is preferably formed integral with the top surface 42 of the cutting die apparatus 40. Alternatively, the cutting surface 44 can be separately formed and subsequently mounted to the top surface 42 using known techniques. The height of the cutting surface 44 relative to the back surface of the die base 41 preferably ranges between about 0.02 inches and about 0.08 inches.

In the configuration shown in FIGS. 2 and 3, the distance between opposing sides of the substantially square shaped continuous cutting surface 44 is about 6 inches. The length of the cutting die apparatus is about 15 inches and the width is about 15 inches. According to this configuration, the maximum thickness of the cutting apparatus 40, which represents the cumulative thickness of the cutting die base 41 and the cutting surface 44, is about 0.04 inches. It is understood that the above recited dimensions are provided only for purposes of illustration, and not of limitation.

The cutting die apparatus 40 also includes one or more bearers or stops 46. The bearers 46 are shown protruding from the top surface 42 of the cutting die apparatus 40. One or more alignment arrangements 48, such as alignment holes, are shown provided on one or more of the bearers 46. The alignment arrangement 48 provides for accurate registration between the cutting die apparatus and an anvil surface when employed in a platen press. It is understood that an alignment arrangement 48 other than alignment holes may be employed as is known in the art. Further, it is understood that the alignment arrangement 48 need not be situated at the bearer 46, but may instead be situated elsewhere on the cutting die apparatus 40.

The bearer or bearers 46 are preferably formed integral with the top surface 42 of the cutting die apparatus 40. Alternatively, the bearer or bearers 46 can be separately formed and subsequently mounted to the top surface 42. The height of each bearer 46 relative to the back surface of the die base 41 preferably ranges between about 0.02 inches and about 0.08 inches.

As is shown in the embodiment of FIGS. 2 and 3, the die base 41 includes first, second, third, and fourth edges 61, 62, 63, 64, where the first and second edges 61, 62 respectively oppose the third and fourth edges 63, 64. The cutting surface 44 includes first, second, third, and fourth cutting edges 51, 52, 53, 54, where the first and second cutting edges 61, 62 respectively oppose the third and fourth cutting edges 63, 64. A first bearer 46a is located between the first edge 61 of the die base 41 and the first cutting edge 51, and a second bearer 46b is located between the third edge 63 of the die base 41 and the third cutting edge 53 of the cuffing surface 44.

Alternatively, or in addition, a third bearer (not shown) can be situated between the second edge 62 of the die base 41 and the second cutting edge 52, and a fourth bearer (not shown) can be situated between the fourth edge 64 of the die base 41 and the fourth cutting edge 54 of the cutting surface 44. The location of the one or more bearers 46 provided on the top surface 42 may be varied as needed or desired.

The cutting die apparatus, including cutting surface 44 and the one or more bearers 46, is preferably formed from a high strength material or metal, such as a hardened steel (e.g., spring steel). The cutting surface 44 can be hardened to have a hardness greater than that of the die base 41 and/or the bearers 46.

As was discussed previously, the height of each bearer 46 relative to the back surface of the die base 41 is substantially equal to the height of the cutting surface 44. In one particular application, the height of the bearers 46 and cutting surface 44 ranges between about 0.02 inches and about 0.08 inches, with about 0.04 inches representing a particularly useful height.

Compliance can be built into the cutting die apparatus 40 by inclusion of a thin compliant material situated between the back surface of the die base 41 and a platen press surface. One, two, or more layers of the compliant material can be employed. The compliant material is preferably formed from a polymeric material, such as polyethylene or polypropylene. Each layer of the compliant material preferably has a thickness ranging between about 0.002 inches and about 0.008 inches.

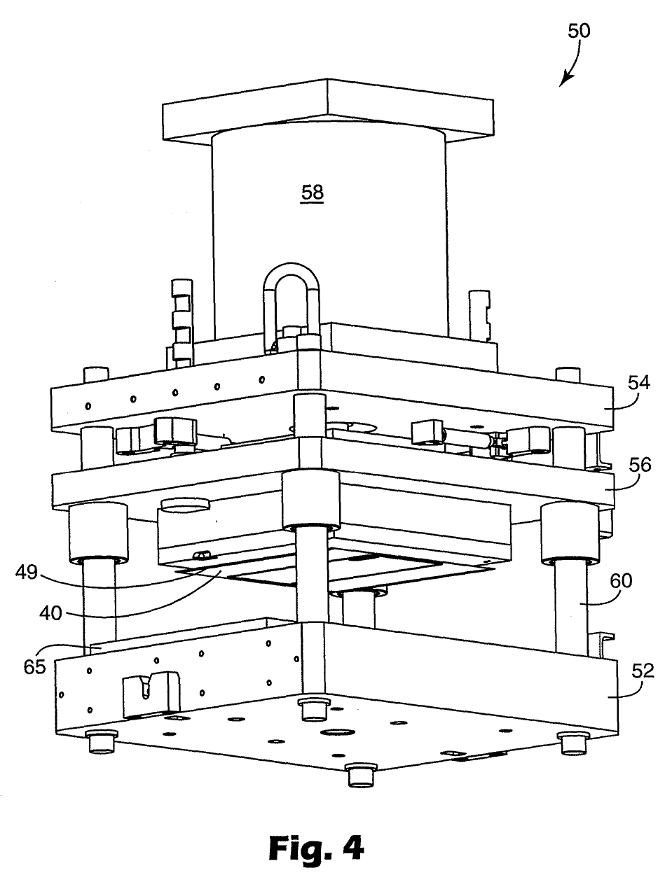

Referring now to FIG. 4, there is illustrated an embodiment of a platen press 50 which incorporates a cutting die apparatus 40 of the present invention. Because the cutting die apparatus 40 of the present invention incorporates one or more bearers or stops 46, the need for expensive external press stroke stops provided on the platen press is obviated, as is the need for careful adjustment of such stops by a skilled machinist after each die change.

The platen press 50 shown in FIG. 4 includes a base plate 52 to which a number of supports 60 are attached. Also connected to the supports 60 is a top plate 54. The base and top plates 52, 54 are typically stationary structures. A moveable plate 56 slidably engages the supports 60 and is movable relative to the base and top plates 52, 54. Movement of the moveable plate 56 is controlled by an actuator 58 shown mounted to the top plate 54. The actuator 58 is typically a pneumatic or hydraulic actuator which can be controlled to move the moveable plate 56 toward and away from the base plate 52. The actuator 58 can be controlled by an appropriate control device.

The base plate 54 of the platen press 50 includes an anvil surface 65. The anvil surface 65, as discussed previously, is formed from a hard material, such as hardened metal. In applications in which very thin material layers are to be cut, it is desirable to include one or more compliant backers 49 between the back side of the cutting die apparatus 40 and the adjacent support surface of the moveable plate 56. In one application, two compliant backers 49 each having a thickness ranging between about 0.004 inches and about 0.006 inches can be situated between the back side of the cutting die apparatus 40 and the adjacent support surface of the moveable plate 56.

In operation, a thin layer of material to be cut is appropriately placed on the anvil surface 65 of the base plate 52. A control signal, which may be a hydraulic, pneumatic or electrical signal, is communicated to the actuator 58. In response to the control signal, the actuator 58 moves the moveable plate 56 and cutting die apparatus 40 toward the anvil surface 65. As the cutting die apparatus 40 contacts the layer of material resting or otherwise being held in place on the anvil surface 65, such as by use of a vacuum, the force generated by the actuator 58 causes the cutting surface 44 of the cutting die apparatus 40 to penetrate the layer of material.

The moveable plate 56 continues to move toward the anvil surface 65 under the force generated by the actuator 58 until the bearer(s) 46 contact the anvil surface 65. Because the bearer(s) 46 are substantially the same height as the cutting surface 44, the cutting surface 44 makes slight contact with the anvil surface 65 to complete the cut to the layer of material, but is prevented from further movement toward the anvil surface 65 by contact between the bearer(s) 46 contact the anvil surface 65. As such, damage to the cutting surface 44 is prevented.

After cutting the layer of material, a control signal communicated to the actuator 58 causes the actuator 58 to retract the moveable plate 56 to a non-engaged position relative to the anvil surface 65. The cut layer of material can then be removed from the anvil surface 65, either automatically or manually. The above described cutting process is repeated for subsequent material layers.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A cutting apparatus for use with a platen die station for cutting relatively thin planar material layers, comprising:
a die comprising a substantially planar first surface and a substantially planar second surface;
a cutting surface protruding from the first surface of the die; and
at least one bearer surface protruding from the first surface of the die, a height of the bearer surface substantially equal to a height of the cutting surface, such that the bearer surface prevents damage to the cutting surface when the cutting surface and bearer surface are moved to contact an anvil surface of the platen die station.

2. The apparatus of claim 1, wherein one bearer surface protrudes from the first surface of the die.

3. The apparatus of claim 1, wherein a first bearer surface is located proximate a first edge of the cutting surface and a second bearer surface is located proximate a second edge of the cutting surface.

4. The apparatus of claim 1, wherein the die comprises first, second, third, and fourth edges, the first and second edges respectively opposing the third and fourth edges of the die, a first bearer surface is located proximate the first edge of the die and a second bearer surface is located proximate the third edge of the die.

5. The apparatus of claim 4, wherein a third bearer surface is located proximate the third edge of the die and a fourth bearer surface is located proximate the fourth edge of the die.

6. The apparatus of claim 1, wherein the cutting surface comprises a continuous cutting edge.

7. The apparatus of claim 1, wherein the cutting surface comprises a discontinuous cutting edges.

8. The apparatus of claim 1, wherein the cutting surface has a substantially square or substantially rectangular shape.

9. The apparatus of claim 1, wherein the cutting surface has a substantially oval or substantially circular shape.

10. The apparatus of claim 1, wherein the cutting surface comprises an outer cutting edge and one or more inner cutting edges respectively situated within the outer cutting edge.

11. The apparatus of claim 1, wherein the cutting surface is integral with the die.

12. The apparatus of claim 1, wherein the die, the cutting surface, and the at least one bearer surface are respectively formed from a high strength metal.

13. The apparatus of claim 1, wherein the at least one bearer surface comprises an alignment arrangement, the alignment arrangement located on the at least one bearer surface to register with an alignment arrangement of the platen die station.

14. The apparatus of claim 13, wherein the alignment arrangement comprises at least one alignment hole.

15. The apparatus of claim 1, wherein the height of the bearer and cutting surfaces ranges between about 0.02 inches and about 0.08 inches, respectively.

16. The apparatus of claim 1, further comprising one or more layers of a compliant material in contact with the second surface of the die.

17. The apparatus of claim 16, wherein the compliant material comprises a polymeric material.

18. The apparatus of claim 16, wherein the compliant material comprises polyethylene or polypropylene.

19. The apparatus of claim 16, wherein each compliant material layer has a thickness ranging between about 0.002 inches and about 0.008 inches.

20. A platen die assembly for cutting relatively thin planar material layers, comprising:
a first plate and a second plate, the second plate comprising an anvil surface, the first plate and second plate arranged to permit relative movement therebetween;
a die comprising a substantially planar first surface and a substantially planar second surface, the second surface of the die affixed to the first plate;
a cutting surface protruding from the first surface of the die;
at least one bearer surface protruding from the first surface of the die, a height of the bearer surface substantially equal to a height of the cutting surface; and
an actuator that effects contact between the first and second plates, the bearer surface preventing damage to the cutting surface when the cutting surface and bearer surface are moved to contact the anvil surface of the second plate under pressure.

21. The assembly of claim 20, wherein one bearer surface protrudes from the first surface of the die.

22. The assembly of claim 20, wherein a first bearer surface is located proximate a first edge of the cutting surface and a second bearer surface is located proximate a second edge of the cutting surface.

23. The assembly of claim 20, wherein the die comprises first, second, third, and fourth edges, the first and second edges respectively opposing the third and fourth edges of the die, and a first bearer surface is located proximate the first edge of the die and a second bearer surface is located proximate the third edge of the die.

24. The assembly of claim 23, wherein a third bearer surface is located proximate the third edge of the die and a fourth bearer surface is located proximate the fourth edge of the die.

25. The assembly of claim 20, wherein the cutting surface comprises a continuous cutting edge.

26. The assembly of claim 20, wherein the cutting surface comprises a discontinuous cutting edges.

27. The assembly of claim 20, wherein the cutting surface has a substantially square or substantially rectangular shape.

28. The assembly of claim 20, wherein the cutting surface has a substantially oval or substantially circular shape.

29. The assembly of claim 20, wherein the cutting surface comprises an outer cutting edge and one or more inner cutting edges respectively situated within the outer cutting edge.

30. The assembly of claim 20, wherein the cutting surface is integral with the die.

31. The assembly of claim 20, wherein the die, the cutting surface, and the at least one bearer surface are respectively formed from a hardened metal.

32. The assembly of claim 20, wherein the at least one bearer surface comprises an alignment arrangement, the alignment arrangement located on the at least one bearer surface located to register with an alignment arrangement of the second plate.

33. The assembly of claim 20, wherein the height of the bearer and cutting surfaces ranges between about 0.02 inches and about 0.08 inches, respectively.

34. The assembly of claim 20, further comprising one or more layers of a compliant material situated between the second surface of the die and the first plate.

35. The assembly of claim 34, wherein the compliant material comprises a polymeric material.

36. The assembly of claim 34, wherein the compliant material comprises polyethylene or polypropylene.

37. The assembly of claim 34, wherein each of the compliant material layers has a thickness ranging between about 0.002 inches and about 0.008 inches.
